(19) United States
(12) Patent Application Publication
(10) Pub. No.: US 2011/0308477 A1
(43) Pub. Date: Dec. 22, 2011

(54) Dog Tug Apparatus and Method of Use

(76) Inventor: Ahmed Khan Durrani, Laguna Hills, CA (US)

(21) Appl. No.: 13/162,243

(22) Filed: Jun. 16, 2011

Related U.S. Application Data
(60) Provisional application No. 61/355,505, filed on Jun. 16, 2010.

(51) Int. Cl. A01K 15/02; A01K 29/00

(52) U.S. Cl. 119/709

(57) ABSTRACT

A dog tug apparatus includes a housing having a dispensing portion and a tug device configured to extend from and retract back into the housing. The tug device includes a tug having teeth scrubbing bristles extending there from. A resistance assembly resists unwinding of the tug line, and includes first and second opposing electromagnets suspended about the periphery of a slotted metal disk. A controller can adjust the resistance applied by the resistance assembly and provide an audible signal at the end of an exercise event. A recovery mechanism provides a means for rewinding the tug line about the spool after the tug line has been unwound, such as during a dog exercise event. In use, the rotation of the spool in the direction to unwind the tug line rotates a reduction gear system and results in the rotation of a treat dispensing mechanism to dispense a dog treat.

### CROSS-REFERENCE TO RELATED APPLICATIONS

The present invention claims the benefit of U.S. Provisional Patent Application Ser. No. 61/355,505, filed Jun. 16, 2010, entitled “The Dog Tug/Puppy Tug”.

### BACKGROUND OF THE INVENTION

1. Field of the Invention

The present invention pertains to the art of exercise devices for animals and, more particularly, to a mechanical dog tug apparatus and method of use.

2. Discussion of the Prior Art

In general, it is known to provide an exercise device for dogs comprising a toy or tug intended to be pulled on by the dog, with a spring providing resistance to the pulling action of the tug, as demonstrated by U.S. Pat. No. 2,698,598. Such devices are not readily adjustable and the resistance spring is not able to be well controlled. While the '598 device is intended to be mounted to a wall, it is also known to provide dog tugs designed for interactive play between a dog and its owner. U.S. Patent Application Publication No. 2009/0151643 is one example of an interactive dog tug which includes a treat-dispensing handle portion and adjustable spring resistance. Such devices require the participation of a human and do not provide for well controlled extension and retraction of the device. Additionally, the actual tugs of the above-identified prior art devices do not provide any benefit to the dog beyond providing a medium for the dog to grab.

Therefore, there is seen to be a need in the art for a dog tug apparatus that provides controlled extension and retraction of a dog tug. Further, there is seen to be a need in the art for a dog tug that is beneficial to the dog's dental hygiene.

### SUMMARY OF THE INVENTION

The present invention is directed to a dog tug apparatus including a housing having a dispensing portion and a tug device configured to extend from and retract back into the housing. The dog tug apparatus further includes structure for mounting the housing to a support structure, such as a wall of a house. The tug device includes a tug having a plurality of teeth scrubbing bristles extending outward which act to clean the teeth of a dog utilizing the device. Within a machine compartment of the housing is a spool about which a tug line in wound. A resistance assembly resists unwinding of the tug line. In a preferred embodiment, the resistance assembly includes first and second opposing electromagnets suspended about the periphery of a slotted metal disk. The rotation of the spool causes the slotted metal disk to turn, and the first and second electromagnets induce a current in the metal disk that creates a counter force to the rotation of the disk and spool. The faster the metal disk spins, the greater the counter force generated. The resistance assembly preferably also includes a variably resistance mechanism which creates additional and variable resistance against the unwinding of the spool. A recovery mechanism provides a means for rewinding the tug line about the spool after the tug line has been unwound, such as during a dog exercise event.

The dog tug apparatus also includes a treat dispensing mechanism having a storage container for storing treats therein, a treat dispensing wheel, and a reduction gear system. In use, rotation of the spool in a direction to unwind the tug line rotates the reduction gear system and results in rotation of the treat dispensing mechanism. The reduction gear system is preferably configured to rotate the treat dispensing wheel to dispense a treat only once during a dog exercise event.

More specifically, during a dog exercise event, a dog grips the tug in its mouth and pulls on the tug line, thus unwinding the tug line from the spool. The resistance assembly provides a force opposing the force applied by the dog to unwind the tug line. At a predetermined point in the unwinding of the tug line, the treat dispensing wheel dispenses a treat through a treat dispensing opening of the housing. Once the dog releases the tug, the recovery mechanism provides the force to rewind the tug line about the spool.

A controller, in communication with a potentiometer, is preferably included to adjust the resistance of the resistance assembly to the rotation of the spool. Preferably, the controller is in communication with an audio device and configured to output an audio signal at the completion of an exercise event or concurrent with the dispensing of a treat.

Thus, the dog tug apparatus is designed for a dog to play tug-of-war by itself, which provides the dog with mental and physical stimulation while also performing the important task of cleaning the dog's teeth. The dog tug apparatus is designed to reward the dog with a treat upon completing an exercise event, thereby encouraging further beneficial use of the device. Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a front perspective view of a dog tug apparatus of the present invention;

FIG. 2 is a rear perspective view of the dog tug apparatus of FIG. 1;

FIG. 3 is a partial cross-section view of a dog tug of the present invention grasped by a dog;

FIG. 4 is a partial cross sectional view of the machine compartment of the dog tug apparatus of FIG. 1;

FIG. 5 is a side view of a metal disk and electromagnet of a resistance assembly utilized with the present invention;

FIG. 6 is a side view of a cam and cam follower of a variable resistance mechanism utilized with the present invention;

FIG. 7 is a side view of a treat dispensing mechanism of the present invention;

FIG. 8 is an example of a reduction gear system for use with the present invention;

FIG. 9 is a perspective side view of a dog utilizing the dog tug apparatus of FIG. 1 during an exercise event; and

FIG. 10 is a schematic drawing of a control system for use with the present invention.

### DETAILED DESCRIPTION OF THE PREFERRED EMBODIMENTS

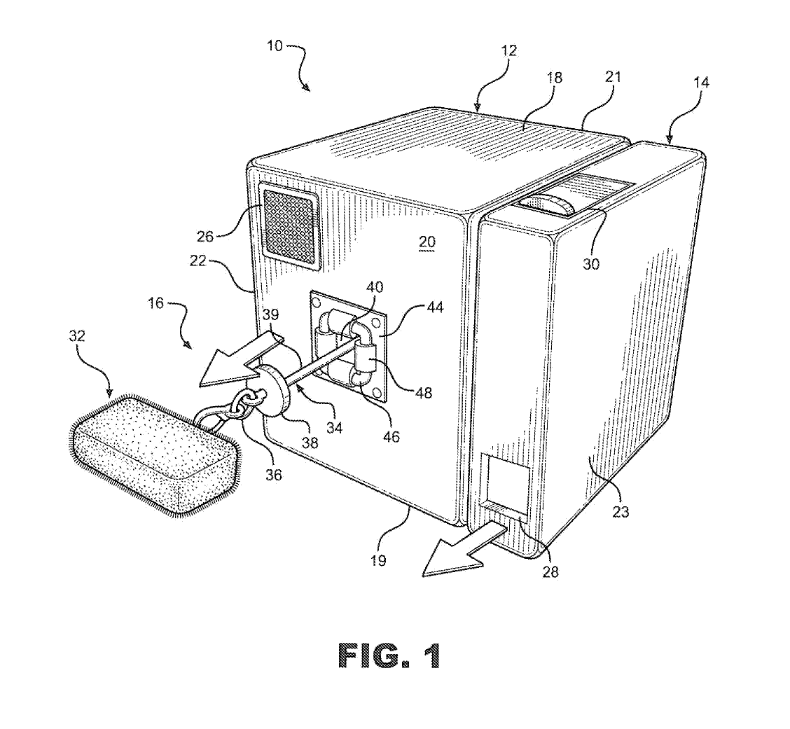

With initial reference to FIG. 1, a dog tug apparatus 10 is depicted. In general, dog tug apparatus 10 includes a housing 12 having a dispensing portion 14, and a tug device generally indicated at 16. While shown as a separate portion attached to housing 12, dispensing portion 14 can optionally be seamlessly incorporated into housing 12. In the preferred embodiment shown, housing 12 includes top, bottom, front, back and opposing side portions 18-23. Housing 12 preferably includes a speaker or audio device 26, as well as a treat dispensing opening 28 and an access door 30 providing a user with selective access for loading dispensing portion 14. Tug device 16 includes a tug 32, configured to be grasped within the mouth of a dog, attached to an extension/retraction tug line 34 at a mounting portion 36. As indicated by the arrow in FIG. 1, tug line 34 is adapted to extend from housing 12, and once extended, to retract back into housing 12 in a manner which will be discussed in more detail below. Tug line 34 may be in the form of a natural or man-made rope, or cable. A retraction stop 38 is attached to an end portion 39 of tug line 34 and is sized to prevent mounting portion 36 and tug 32 from being retracted through a tug line aperture 40 in housing 12, or from being fully retracted against front wall 20. Preferably, a plate 44 is mounted about the periphery of aperture 40 and includes a bumper 46 having low friction portions 48 that prevent substantial wear on tug line 34 due to repeated extensions and retractions of tug line 34 from housing 12.

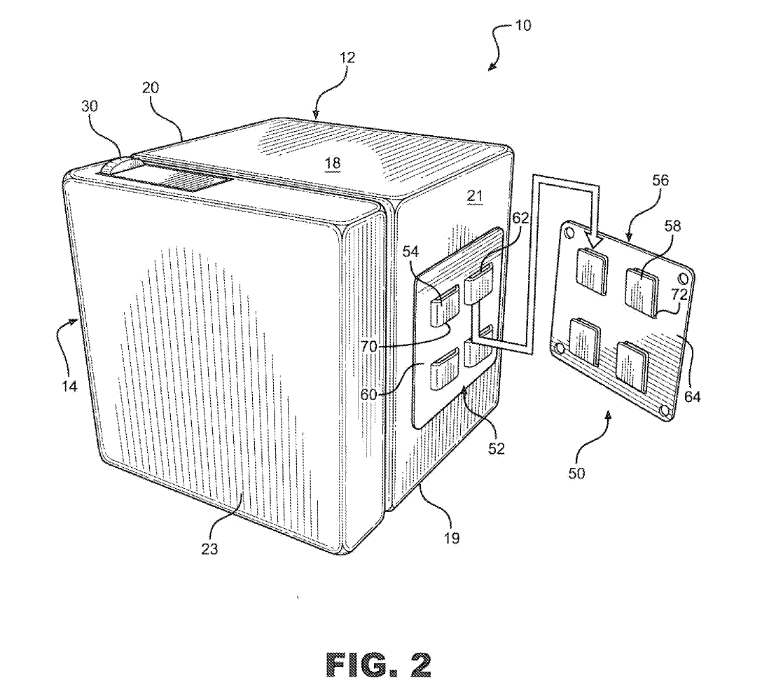

As depicted in FIG. 2, dog tug apparatus preferably includes means 50 for mounting housing 12 to a support structure. Means 50 is preferably in the form of a first mounting plate 52 including a plurality of first, female mounting members 54, and a second mounting plate 56 including a plurality of second, male mounting elements 58 adapted to engage respective female mounting members 54. In the embodiment shown, female mounting members 54 take the form of loops extending from a main body 60 of mounting plate 52, the loops defining apertures 62 into which male mounting elements 58 may be inserted. More specifically, male mounting elements 58 are preferably in the form of tabs extending upwardly from a main body 64 of mounting plate 56. In use, first mounting plate 52 is mounted to one of opposing side walls 22, 23 and back wall 21. First mounting plate 52 can be mounted to housing 12 through any conventional means, such as through adhesive or mechanical fasteners (not shown), although first mounting plate 52 could also be integrally formed with housing 12. Second mounting plate 56 may be mounted to any support structure that is strong enough to support dog tug apparatus 10 in a stationary manner when dog tug apparatus 10 is subjected to forces from a dog tugging on tug device 16. Second mounting plate 56 is mounted to a support structure through any conventional means, such as through adhesive or mechanical fasteners (not shown). The support structure can be a tree, staircase, wall or any fixture that will tightly hold the device in place. When a user wishes to mount housing 12 to the support structure, a user simply lifts housing 12 such that tabs 58 are positioned adjacent a bottom opening of apertures 62, and then lowers housing 12 such that tabs 58 slide within respective apertures 62 of loops 54 until a bottom wall 70 of respective loops 54 abuts, and is support by, a bottom wall 72 of tabs 58. In this way, the weight of housing 12 is supported by a particular support structure, such as a wall, through the engagement of first and second mounting plates 52 and 56. Alternatively, first mounting plate 52 can be mounted to bottom wall 19, such as when second mounting plate 56 is mounted to a floor. In yet another embodiment not shown, housing 12 can be staked to or otherwise fixed to the ground.

Tug 32 will now be discussed in more detail with reference to FIG. 3. Tug 32 includes a plurality of teeth scrubbing bristles 80 extending outward from a flexible wall 82 of tug 32, which function to aid in the removal of debris from the teeth of a dog, as well as massage the dog's gums. Flexible wall 82 is preferably made from a pet-safe polymer, such as foam rubber. The flexibility of wall 82 can vary, but preferably provides a tough and resilient surface into which a dog can sink its teeth and/or get a substantial mouth grip on, but which will survive the rigors of repeated exercise or tugging events. Although depicted as hollow, tug 32 can be solid or constructed of multiple layers of materials having varying thicknesses, depending on the desired characteristics of tug 32, such as durability and flexibility. For example, a sheep skin or other material to attract a dog's attention (not shown) can be inserted into tug 32. In an alternative embodiment (not shown), wall 82 can include apertures therein through which a dog's teeth can penetrate and a mesh within tug 32 can be positioned to engage teeth penetrating wall 82 to provide additional scrubbing surfaces for cleaning and flossing the teeth of the dog.

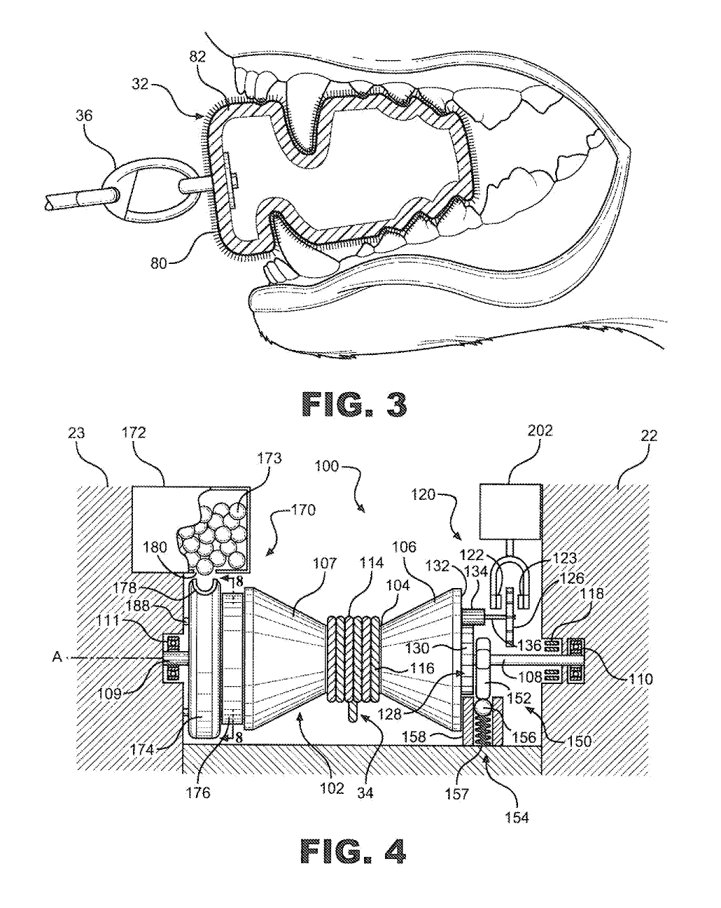

A means for resistance to the unreeling of tug line 34 will now be discussed with reference to FIG. 4. FIG. 4 depicts a partial cross-sectional view of housing 12, which includes a machine compartment generally indicated at 100. A drum or spool 102 located within machine compartment 100 includes an intermediate portion 104 connecting opposing sloping side portions 106, 107. Axle rods 108, 109 extend from respective sloping side portions 106, 107 and rotatably support spool 102 about an axis A within machine compartment 100 through their engagement with respective bearing mounts 110, 111 connected to respective side walls 22 and 23. As depicted in FIG. 1, first end portion 39 of tug line 34 extends out through tug line aperture 40 in housing 12, while an intermediate portion 114 of tug line 34 is wrapped around spool 102 in a wound position as depicted in FIG. 4. An end portion of tug line 34 indicated at 116 is secured to spool 102 using any known connection method in the art. Due to a dog's natural tendencies, a dog chewing on tug 32 will instinctively pull and tear at tug 32, leading to the unwinding of tug 32 from spool 102. A recovery mechanism 118 is provided to establish a means for rewinding tug line 34 about spool 102 after tug line 34 has been unwound. In the preferred embodiment shown, recovery mechanism 118 is in the form of a spiral spring connected at one end to axle rod 108 and side portion 22 of housing 12 at another end. As spool 102 rotates in a direction to unwind tug line 34 from about spool 102, the spiral spring coils such that tension is introduced into recovery mechanism 118. When tug line 34 is released, the stored energy in recovery mechanism 118 provides the force to rotate spool 102 in a direction to rewind tug line 34 about spool 102.

A resistance assembly generally indicated at 120 applies resistance to tug line 34 in the direction of extension or unwinding depicted by the arrow in FIG. 1, while allowing a dog to slowly unwind tug line 34 from about spool 102. In a preferred embodiment, resistance assembly includes first and second opposing electromagnets 122 and 123 suspended about the periphery of a slotted metal disk 126. Slotted metal disk 126 is rotatably connected to spool 102 through a speed multiplier gear system 128. More specifically, a main gear 130 is connected to a side wall 132 of sloping side portion 106. Alternatively, main gear 130 may be connected directly to axle rod 108. In either configuration, the rotation of spool 102 about axis A causes main gear 130 to rotate. A speed multiplying gear 134 connected to slotted metal disk 126 by an axle rod 136 is in communication with first gear 130. The rotation of first gear 130 causes speed multiplying gear 134, and hence slotted metal disk 126, to turn at an increased frequency with respect to first gear 130. As can best be seen in FIG. 5, metal disk 126 includes a solid inner portion 140 through which axle rod 136 extends, and a slotted outer portion 142 comprising a plurality of spaced tabs 144 separated and defined by a plurality of spaced slots 146. As metal disk 126 spins in a direction D due to the rotation of gears 130 and 134, first and second electromagnets 122 and 123 induce a current in metal disk 12. Slots 146 limit the mobility of the electrical charges and a counter force is generated opposing the movement of metal disk 126 in direction D. It should be understood that the faster metal disk 126 spins, the greater the counter force generated. When metal disk 126 stops spinning, the counter force goes to zero. Alternatively, resistance assembly 120 can be in the form of a standard pulley and coil mechanism (not shown) which provides a counter force to the unreeling of tug line 34 from about spool 102. Tension in this type of device can be adjusted for a particular type or class of dog.

With reference to FIGS. 4 and 6, resistance assembly 120 preferably also includes a variably resistance mechanism generally indicated at 150. Variable resistance mechanism 150 includes a cam 152 and a cam follower unit 154. In the particular embodiment shown, cam follower unit 154 includes a cam follower 156 in the form of a ball, as well as a spring 157 retained within a housing 158 and biasing ball 156 into engagement with cam 152. Cam 152 is mounted to axle rod 108 and includes a plurality of arms 160. As axle rod 108 rotates, cam 152 is also rotated, causing arms 160 to spin and consecutively engage/disengage follower 156. In the particular embodiment shown, as cam 152 rotates, one of the plurality of lobes or arms 160 will engage ball 156, and as cam 152 continues to rotate, will pushing ball 156 down against spring 157 until the arm passes by ball 156, at which point spring 157 will push ball 156 upwards, back to a starting position. Thus, it should be understood that cam follower unit 154 provides a force against the rotation of cam 152 that will vary as the plurality of arms 160 moves into and out of contact with cam follower unit 154.

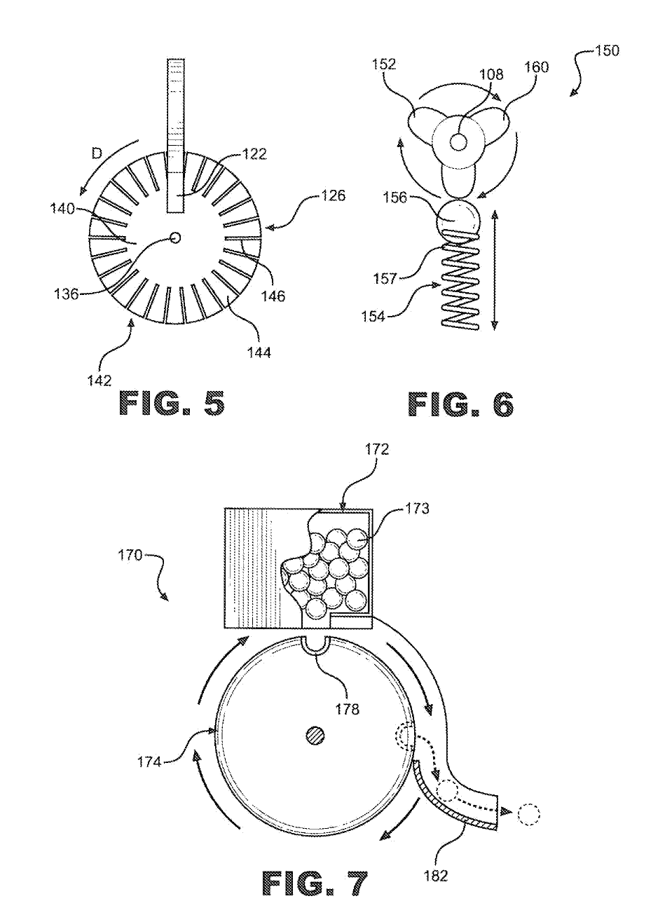

A treat dispensing mechanism 170 of the present invention will now be discussed with reference to FIGS. 4, 7 and 8. In general, treat dispensing mechanism 170 includes a storage container 172 for storing treats 173 therein, a treat dispensing wheel 174, and a reduction gear system 176. Storage container 172 is accessible by a user through access door 30 (shown in FIG. 1), and can be filled with any desired type of animal treat. In general, reduction gear system 176 is connected to spool 102 and/or axle rod 109, and is also connected to treat dispensing mechanism 170. In use, the rotation of spool 102 in the direction to unwind tug line 34 from about spool 102 rotates reduction gear system 176 and results in a reduced rotation of treat dispensing wheel 174 through its connection to reduction gear system 176. Reduction gear system 176 is preferably configured to rotate treat dispensing wheel 174 only once from a starting position, wherein a treat carrying portion 178 of treat dispensing wheel 174 is adjacent an opening 180 of storage container 172, to a position wherein treat carrying portion 178 dispenses a treat 173. In a preferred embodiment, treat 173 is dispensed from opening 180 into treat carrying portion 178 as treat dispensing wheel 174 is rotated, and treat 173 is guided by a sloped dispensing slide 182 (depicted in FIG. 7) to treat dispensing opening 28 of housing 12 (depicted in FIG. 1). The trigger point, or point in the unreeling of tug line 34 at which a treat 173 is dispensed from housing 12 can be adjusted, depending on the type of exercise/play experience desired for a particular dog. Therefore, it should be readily understood that reduction gear system 176 can be configured to rotate treat dispensing wheel 174 any desired number of full rotations during the unwinding of tug line 34 in order to dispense a desired number of treats 173. More specifically, the trigger point can be adjusted by adjusting the ratio of rotation between spool 102/axle rod 109 and treat dispensing mechanism 170 via reduction. gear system 176. A user may adjust the trigger point based on a dog's height, weight, strength and body makeup. Treat 173 can be anything from a small piece of a sausage to a cookie or whatever the pet owner decides as a reward.

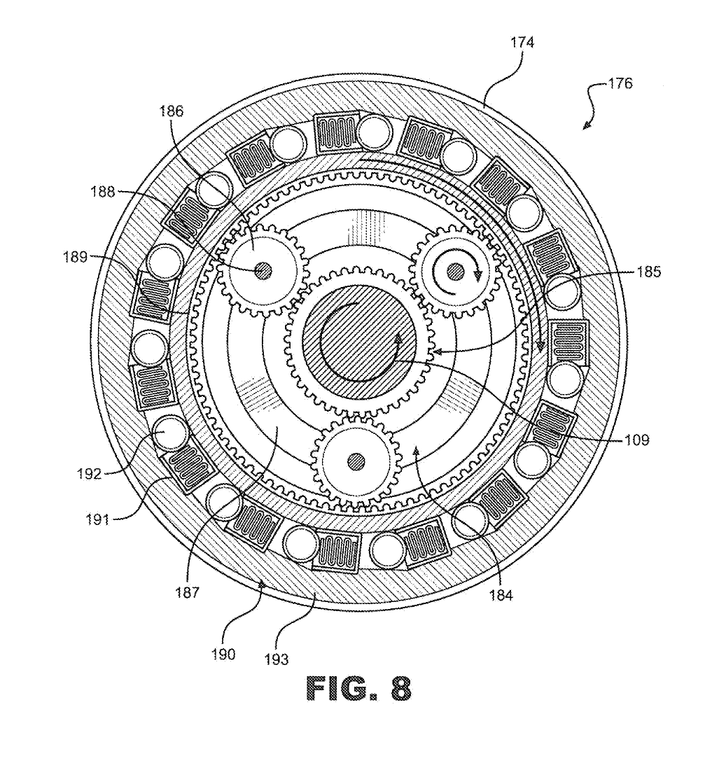

Any known reduction gear system could be utilized with the present invention. For illustrative purposes, FIG. 8 a cross section of reduction gear system 176 along the line 8-8 shown in FIG. 4. Gear system 176 includes a planetary gear mechanism 184 with a sun gear 185 fixed to shaft 109 so that as spool 102 rotates (when being pulled by tug line 34), shaft 109 rotates in a counterclockwise manner. A set of planetary gears 186 is mounted on a planetary carrier 187. Planetary carrier 187 is preferably stationary and is configured to support planetary gears 186 so that they each rotate. Planetary carrier 187 is preferably mounted by shafts 188 extending through a central axis of each planetary gear 186 and into housing 12, as best seen in FIG. 4. A ring gear 189 is located radially outward of planetary gears 186 and is also mounted for rotation. Teeth on sun gear 185 intermesh with teeth on the planetary gears 186. Similarly, teeth are provided on an inner peripheral surface of ring gear 189 so as to intermesh with the teeth on the planetary gears 186. With this arrangement, as central shaft 109 rotates in a counterclockwise manner, the intermeshing gears will cause planetary gears 186 to rotate clockwise and ring gear 189 to also rotate clockwise but at a much slower speed than sun gear 185. The relative speed of ring gear 189 and sun gear 185 is set by the size of the gears and the number of teeth on each gear. In other words, a small sun gear 185 and a large ring gear 189 will cause ring gear 189 to rotate slower with a constant input speed of shaft 109 than if a larger sun gear 185 is employed.

A one-way clutch 190 is mounted radially outward of planetary gear mechanism 184 and connects ring gear 189 to and outer member that is connected to treat dispensing wheel 174. One-way clutch 190 includes a set of springs 191 and rollers 192. As ring gear 189 rotates counter clockwise, rollers 192 are pushed against springs 191, and rollers 192 tend to separate from an outer ring portion 193. Thus, as ring gear 180 rotates counter clockwise, rollers 192 slip and do not grip outer ring portion 193 such that no torque is transmitted from ring gear 189 to treat dispensing wheel 174. However, when ring gear rotates 189 clockwise, rollers 192 are wedged against cam surfaces located in outer ring portion 193 and do transmit torque, forcing treat dispensing wheel 174 to rotate. Therefore, treat dispensing wheel 174 will rotate when spool 102 is being unwound but not when spool 102 is being wound.

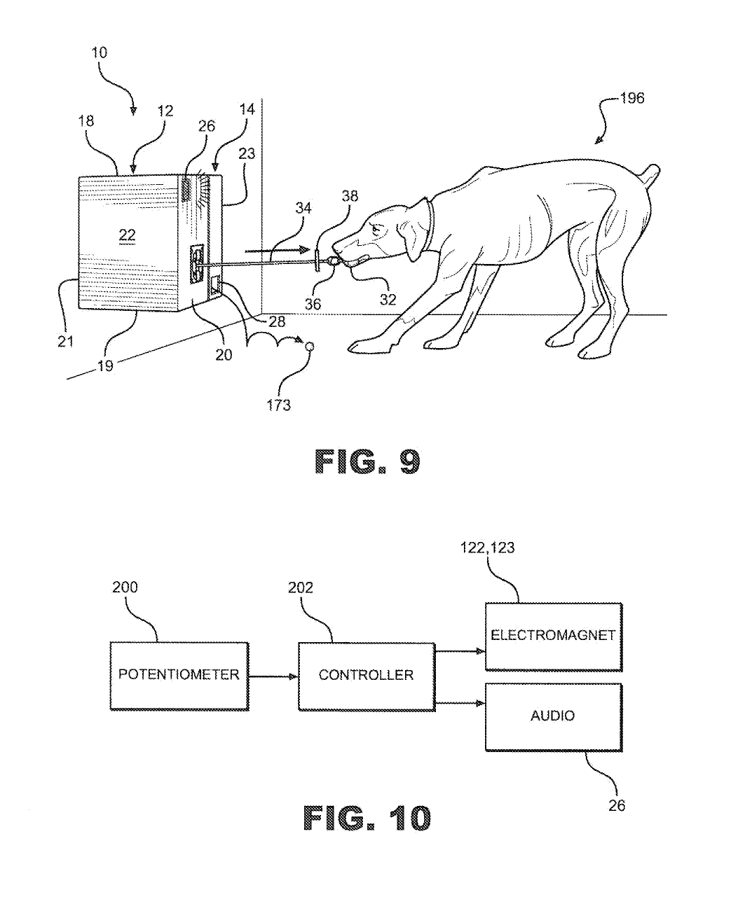

The method by which dog tug apparatus 10 operates during an exercise event will now be discussed with reference to FIGS. 4 and 9.

Initially, housing 12 is mounted to a support structure in the manner described above. When it is time for a dog 190 to play/exercise, dog 196 grips tug 32 in its mouth and applies a force in a direction away from housing 12, thus pulling on tug line 34 and moving tug line 34 from a start position in which tug line 34 is wound about spool 102 toward an unwound position in which an amount of tug line 34 is unwound from spool 102. Resistance assembly 120 provides a force opposing the force applied by dog 196 to unwind tug line 34, which encourages dog 196 to fight and pull away from housing 12 until tug line 32 is unwound a predetermined amount from spool 102. It should be understood that the length of tug line 32 can be adjusted to provide for the desired exercise/play experience. The tension of tug line 34 works the dog's neck, shoulder, legs and entire body. In a preferred embodiment, resistance mechanism 150 provides an additional variable resistance against the force applied by dog 196. At a predetermined point in the unwinding of tug line 34, treat dispensing wheel 174 dispenses a treat 173 through treat dispensing opening 28 of housing 12. Once the dog releases tug 32, recovery mechanism 118 provides the force to rotate spool 102 in a direction to rewind tug line 34 about spool 102 until dog tug apparatus 10 is again in its start position.

With further reference to FIGS. 4 and 9, dog tug apparatus 10 preferably also includes a potentiometer 200, adapted to sense the rotation of spool 102, in communication with a controller 202 which adjusts the resistance in the current path of resistance assembly 120. Controller 202 can be adjusted to provide for varying resistance of resistance assembly 120 to the rotation of spool 102, and thus to the unwinding of tug line 34 from spool 102 during an exercise event. Additionally, controller 202 is preferably in communication with audio device 26 and is configured to instigate an audio signal from audio device 26 after spool 102 has rotated a predetermined amount, such as at the completion of an exercise event or concurrent with the dispensing of a treat 173.

As described above, the dog tug apparatus of the present invention is designed for a dog to play tug-of-war by itself, providing the dog with mental and physical stimulation while also performing the important task of cleaning the dog's teeth. The dog tug apparatus provides solutions to existing and ongoing behavioral and physical problems associated with dogs, including: a legal outlet for rough housing; positive reinforcement; redirects the natural impulse of dogs to bite to an appropriate outlet; prevents damage from inappropriate chewing; provides exercise for the dog, which makes the dog less likely to engage in inappropriate behavior; exercises the dog's neck and jaw muscles; creates a useful distraction for the dog's natural energy; enabling a low key game of tug to change a dog's emotional state from anxious to happy; builds confidence without an owner's participation; and provides an easy and convenient way to maintain a dog's daily oral hygiene. Although described with reference to preferred embodiments of the invention, it should be readily understood that various changes and/or modifications can be made to the invention without departing from the spirit thereof. For instance, although depicted as including a substantially square housing, housing 12 could take on any shape. In general, the invention is only intended to be limited by the scope of the following claims.

1. A dog tug apparatus comprising:
a housing configured to be mounted to a stationary object, said housing defining a machine compartment and having a wall including a tug line aperture;
a tug line system within the machine compartment including:
a tug line having a first end portion, a second end portion extending through the tug line aperture of the housing, and a middle portion interconnecting the first and second end portions;
a spool having the first end portion of the tug line attached thereto and configured to store the tug line in a reeled position; wherein the spool is mounted within the machine compartment for rotation about an axis in a reeling direction and an opposing unreeling direction;
a tug attached to the second end portion of the tug line outside of the housing;
a resistance assembly providing resistance to the unreeling of the tug line; and
a recovery mechanism connected to the spool and providing a force to rotate the spool in the reeling direction.

2. The dog tug apparatus of claim 1, wherein the tug is a teeth scrubbing tug including bristles adapted to engage the teeth of an animal biting the teeth scrubbing tug to aid in the removal of debris from the teeth.

3. The dog tug apparatus of claim 1, wherein the resistance assembly includes at least one electromagnet positioned adjacent a slotted metal disk, wherein the slotted metal disk is rotatably connected to the spool.

4. The dog tug apparatus of claim 3, wherein the slotted metal disk is rotatably connected to the spool by a gear assembly such that rotating the spool about the axis causes rotation of the slotted metal disk.

5. The dog tug apparatus of claim 2, further comprising:
a potentiometer configured to sense the rotation of the spool, wherein the potentiometer is in communication with a controller that controls the resistance supplied by the resistance assembly to the unreeling of the tug line based, at least in part, on signals from the potentiometer to the controller.

6. The dog tug apparatus of claim 1, further comprising:
a dispensing aperture formed in a wall of the housing; and
a treat dispensing system within the machine compartment.

7. The dog tug apparatus of claim 6, wherein the treat dispensing system comprises:
a treat dispensing wheel mounted for rotation about an axis and including a slot formed therein adapted to receive an animal treat from a storage container, wherein the treat dispensing wheel is rotatably connected to the spool by a one-way reduction gear such that rotation of the spool in the unreeling direction results in rotation of the treat dispensing wheel and dispensing of said animal treat from the slot through the dispensing aperture.

8. The dog tug apparatus of claim 7, wherein the one-way reduction gear is configured to rotate the treat dispensing wheel only once during a dog exercise event to dispense said animal treat.

9. The dog tug apparatus of claim 7, further comprising:
an access door located in a wall of the housing providing access to said storage container.

10. The dog tug apparatus of claim 1, further comprising:
an audio device indicating that the spool has rotated a predetermined amount.

11. The dog tug apparatus of claim 1, further comprising:
a variable resistance mechanism configured to provide variable resistance to rotation of the spool in the unreeling direction.

12. The dog tug apparatus of claim 11, wherein the variable resistance mechanism includes a cam rotatably connected to the spool, and a cam follower adapted to sequentially engage a plurality of lobes of the cam.

13. The dog tug apparatus of claim 1, further comprising:
low friction portions located about the tug line aperture configured to prevent wear, on the tug line from repeated reeling and unreeling of the tug line into and out of the housing.

14. A method for exercising a dog utilizing a dog tug apparatus including a tug line, a spool having a first end portion of the tug line attached thereto, the spool storing the tug line thereabout in a reeled position wherein the spool is mounted for rotation about an axis in a reeling direction and an opposing unreeling direction, and a tug attached to a second end portion of the tug line outside of a housing of the dog tub apparatus, the method comprising:
having a dog initiate an exercise event by gripping the tug in its mouth and pulling on the tug line to cause the spool to rotate in the unreeling direction; and
automatically providing resistance to the rotation of the spool in the unreeling direction using a resistance assembly of the dog tug apparatus while allowing the dog to continue to cause the spool to rotate in the unreeling direction.

15. The method of claim 14, wherein the tug is a teeth scrubbing tug and the method further comprises:
scrubbing the dog's teeth with the teeth scrubbing tug during the exercise event.

16. The method of claim 14, further comprising:
dispensing a treat from the dog tug apparatus at a predetermined point in the unreeling of the tug line from the spool.

17. The method of claim 14, further comprising:
increasing the resistance based on an increase in the speed of unwinding of the tug line from the spool.

18. The method of claim 14, further comprising:
controlling the resistance based on signals from a potentiometer.

19. The method of claim 14, further comprising:
signaling via an audio signal that the spool has rotated a predetermined amount.

20. The method of claim 14, further comprising:
providing variable resistance to the pull of the tug line away from the housing using a variable resistance mechanism of the dog tug apparatus.

21. The method of claim 14, further comprising:
reeling the tug line about the spool upon release of the tug line by the dog.
